(19) United States
(12) Patent Application Publication
(10) Pub. No.: US 2007/0070478 A1
(43) Pub. Date: Mar. 29, 2007

(54) Hologram recording medium and reproducing device

(75) Inventor: Toshimasa Aoki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/518,181

(22) Filed: Sep. 11, 2006

(30) Foreign Application Priority Data
Sep. 28, 2005 (JP) 2005-281436

(51) Int. Cl. G03H 1/28

(52) U.S. Cl. 359/24; 359/21

(57) ABSTRACT

The present invention relates to a hologram recording medium in which all unit holograms included in an element hologram are recorded in a predetermined area and the unit holograms are redundantly recorded in the outer periphery of the predetermined area, and to a reproducing device for the recording medium.

### CROSS REFERENCES TO RELATED APPLICATIONS

The present invention contains subject matter related to Japanese Patent Application JP 2005-281436 filed in the Japanese Patent Office on Sep. 28, 2005, the entire contents of which being incorporated herein by reference.

### BACKGROUND OF THE INVENTION

1. Field of the Invention

The present invention relates to a hologram recording medium in which predetermined amounts of data arising from division of data are recorded, and to a reproducing device that reproduces data from the hologram recording medium.

2. Description of the Related Art

The related arts of the invention are disclosed in e.g. Japanese Patent Laid-Open No. Hei 8-171620, No. Hei 11-272294, and No. Hei 11-330973.

Examples of measures to record information in a sheet recording medium include one-dimensional codes and two-dimensional codes typified by barcodes, QR codes, dot codes, etc. However, in the information recording media employing these measures, the amount of information that can be recorded per unit area is extremely low: about several to several tens of kilobytes. This is because there is a physical limitation on the recording resolution in mere dark and light printing of images.

As another type of the sheet recording medium, a hologram recording medium for recording various kinds of data by use of an interference fringe due to interference between object light and reference light is also known. Furthermore, it is also known that the hologram recording medium allows a dramatic improvement in the recording density and a significant increase in the capacity, and it is considered that the hologram recording medium will be useful as a high-capacity storage medium for e.g. computer data and audio-visual (AV) content data.

When data is to be recorded in a hologram recording medium, the data is converted into an image as two-dimensional (2D) page data. Subsequently, the data converted into an image is displayed on a liquid crystal panel or the like, and the hologram recording medium is irradiated with light that has passed through the liquid crystal panel as object light that forms the image of the 2D page data. In addition, the hologram recording medium is irradiated also with reference light from a predetermined angle. At this time, an interference fringe arising due to the object light and reference light is recorded as one element hologram having a dot shape, strip shape or the like. That is, one element hologram is obtained as a result of recording of one 2D page data.

Consideration will be made below on a system in which computer data, AV content data or the like is recorded in a hologram memory having e.g. a sheet shape and general users can acquire the data recorded in the hologram memory by use of a reproducing device as a hologram reader.

In the sheet hologram memory, a large number of element holograms are recorded in such a manner as to be closely arranged on a plane as the medium surface, and a hologram reader is placed to face the medium surface so that data recorded as the respective element holograms is read.

In such a system, it is needed for the hologram reader to have a capability of stably reproducing data from the hologram memory. In particular, the reproducing device goes through a process of executing decoding for 2D images captured from the element holograms so as to obtain decoded data. In this decoding, it is important that the information included in the 2D images from the element holograms is adequately acquired.

The 2D images of element holograms are imaged by an imaging element unit such as a CCD imaging element array or CMOS imaging element array. In this imaging, the 2D images obtained as reproduced-image light from the element holograms are frequently imaged on the imaging element unit with involving a geometric misalignment from the imaging elements. For example, there is a case where the 2D images are captured with involving a misalignment in the vertical and horizontal directions and a misalignment in the rotational direction. The 2D images obtained in such a state involve lack of part of the information thereof, distortion in the image patterns, and so on, and therefore involve a problem in that the error rate in decoding increases. Thus, the data reproduction performance is deteriorated.

In consideration of the problem, it is desirable to provide a hologram recording medium and a reproducing device that are suitable for e.g. a system in which users can acquire data from a hologram recording medium and allow stable acquisition of reproduced data.

### SUMMARY OF THE INVENTION

According to an embodiment of the invention, there is provided a hologram recording medium in which image data of a predetermined amount of data arising from division of record data into each predetermined amount of data and conversion of the resultant data into image data is recorded as an element hologram by use of an interference fringe due to interference between object light of the image data and recording reference light. In the recording medium, unit holograms included in the element hologram are arranged in a predetermined region so that all of the unit holograms included in the element hologram are contained in a predetermined area.

According to another embodiment of the invention, there is provided a hologram recording medium in which a two-dimensional image arising from conversion of element hologram record data including a plurality of unit data is recorded as one element hologram by use of an interference fringe due to interference between object light of the two-dimensional image and recording reference light. In the hologram recording medium, the two-dimensional image includes an inside area that contains all of the unit data included in the element hologram record data, and an outer peripheral area that surrounds the inside area and contains all or part of the unit data.

According to further another embodiment of the invention, there is provided a reproducing device that reproduces record data from a hologram recording medium in which image data of a predetermined amount of record data arising from division of record data into each predetermined amount of data and conversion of the resultant data into image data is recorded as an element hologram by use of an interference fringe due to interference between object light of the image data and recording reference light. The hologram recording medium has a predetermined region in which unit holograms included in the element hologram are arranged so that all of the unit holograms included in the element hologram are contained in a predetermined area. The reproducing device includes an imaging section configured to emit reproduction reference light to the hologram recording medium and capture a two-dimensional image arising as reproduced-image light from an element hologram on the hologram recording medium, and a decoding section configured to execute decoding processing for a two-dimensional image obtained by the imaging section on each unit data basis and collect decoded unit data to thereby obtain decoded data of one element hologram record data.

### BRIEF DESCRIPTION OF THE DRAWINGS

FIG. 1A is an explanatory diagram of recording in a hologram memory according to an embodiment of the present invention;

FIG. 1B is an explanatory diagram of reproduction from the hologram memory according to the embodiment;

FIG. 2A is a diagram showing division of content data into blocks as one of explanatory diagrams for a 2D image recorded as an element hologram according to the embodiment;

FIG. 2B is a diagram showing data addition to the content data divided into blocks as one of the explanatory diagrams for a 2D image recorded as an element hologram according to the embodiment;

FIG. 2C is a diagram showing data converted into an element hologram as one of the explanatory diagrams for a 2D image recorded as an element hologram according to the embodiment;

FIG. 2D is a diagram showing compositional elements of a 2D image as one of the explanatory diagrams for a 2D image recorded as an element hologram according to the embodiment;

FIG. 2E is a diagram showing unit data as one of the explanatory diagrams for a 2D image recorded as an element hologram according to the embodiment;

FIG. 3 is an explanatory diagram of element holograms on a hologram memory according to the embodiment;

FIG. 4 is an explanatory diagram of the 2D images of element holograms according to the embodiment;

FIG. 5A is a conceptual diagram of an example of manual scanning operation with a hologram reader according to the embodiment;

FIG. 5B is an explanatory diagram of an example of manual scanning operation with a hologram reader according to the embodiment;

FIG. 6 is an explanatory diagram of an example of manual scanning operation with a hologram reader according to the embodiment;

FIG. 7 is an explanatory diagram of pixel blocks included in a 2D image according to the embodiment;

FIG. 8 is an explanatory diagram of a pixel block according to the embodiment;

FIG. 9A is an explanatory diagram of the arrangement of pixel blocks in a 2D image according to the embodiment;

FIG. 9B is an explanatory diagram of the imaging area of an imaging element that images pixel blocks in a 2D image according to the embodiment;

FIG. 10 is an explanatory diagram of an imaging state where a misalignment in the vertical and horizontal directions from the 2D image has occurred according to the embodiment;

FIG. 11 is an explanatory diagram of an imaging state where a misalignment in the rotational direction from the 2D image has occurred according to the embodiment;

FIG. 12 is an explanatory diagram of the arrangement of pixel blocks in a 2D image according to the embodiment;

FIG. 13 is an explanatory diagram of an imaging state where a misalignment in the rotational direction from the 2D image has occurred according to the embodiment;

FIG. 14 is an explanatory diagram of the arrangement of pixel blocks in a 2D image according to the embodiment;

FIG. 15 is an explanatory diagram of an imaging state where a misalignment in the vertical and horizontal directions from the 2D image has occurred according to the embodiment;

FIG. 16 is an explanatory diagram of an imaging state where a misalignment in the vertical, horizontal, and rotational directions from the 2D image has occurred according to the embodiment;

FIG. 17 is an explanatory diagram of the arrangement of pixel blocks in a 2D image according to the embodiment;

FIG. 18 is an explanatory diagram of an imaging state where a misalignment in the vertical, horizontal, and rotational directions from the 2D image has occurred according to the embodiment;

FIG. 19 is a block diagram of a hologram reader according to the embodiment; and

FIG. 20 is a flowchart of reproduction processing of the hologram reader according to the embodiment.

### DETAILED DESCRIPTION OF THE PREFERRED EMBODIMENTS

An embodiment of the invention will be described below in the following order: [1. Recording and Reproducing with Hologram Memory], [2. Recording Configuration of Element Hologram], [3. Configuration of Hologram Reader], and [4. Reproduction Processing].

[1. Recording and Reproducing with Hologram Memory]

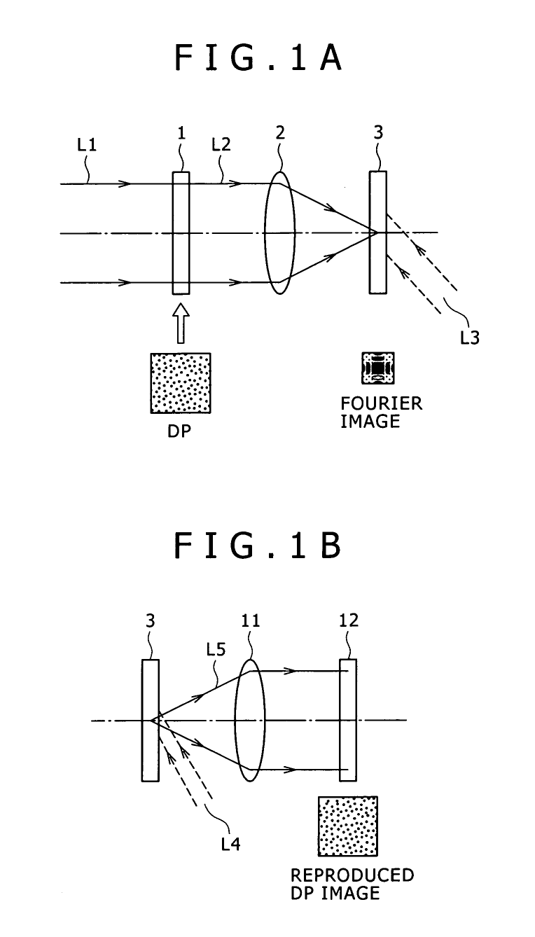

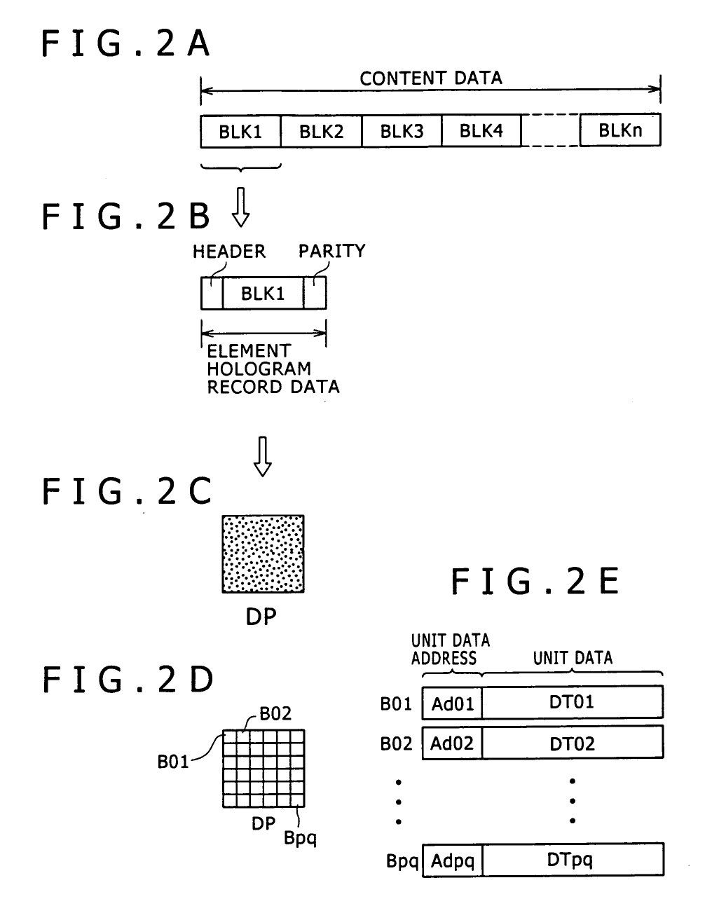

Initially a description will be made on the basic recording operation and reproducing operation with a hologram memory 3 with reference to FIGS. 1 and 2.

FIG. 1A shows how data is recorded in the hologram memory 3. When e.g. content data or data as a computer program or the like is to be recorded in the hologram memory 3, the entire record data is encoded into a large number of one-page data.

For example, as shown in FIG. 2A, entire data such as content data is divided into a large number of data blocks (BLK1 . . . BLKn) each having a predetermined size, and encoding processing is executed on each data block basis.

In the encoding processing, as shown in FIG. 2B, header information and parity for error correction are added to block data, so that the resultant data is treated as element hologram record data DT. The header includes e.g. the address information such as a data block number, the attribute of the content data, the file type, the size of the entire content data, the size of the data block, the number of the data blocks included in the content data.

This element hologram record data DT of FIG. 2B is subjected to interleaving and 2D pattern conversion to thereby be converted into a 2D image DP of FIG. 2C.

As processing for converting the element hologram record data DT into the 2D image DP, e.g. conversion into a 2D pattern on each unit data basis is executed as shown in FIG. 2E.

Unit data DT01, DT02 . . . DTpq in FIG. 2E forms the element hologram record data DT. The unit data DT01, DT02 . . . DTpq is obtained by executing interleaving processing for the element hologram record data DT of FIG. 2B and then dividing the resultant data into data each having a predetermined data size for example. That is, the relationship DT=DT01+DT02+ . . . +DTpq is satisfied.

Unit data addresses Ad01, Ad02 . . . Adpq are added to the unit data DT01, DT02 . . . DTpq, respectively, and the resultant unit data DT01, DT02 . . . DTpq are converted into the respective image patterns as pixel blocks B01, B02 . . . Bpq, respectively.

Each pixel block B (B01, B02 . . . Bpq) includes a predetermined number of pixels arranged along the vertical and horizontal directions (e.g., 16 by 16 pixels), and expresses information of a predetermined number of bytes as the unit data (including the unit data address) by binary information based on bright pixels and dark pixels of the included pixels.

As shown in FIG. 2D, the 2D image DP is formed by arranging the pixels blocks B01, B02 . . . Bpq on a 2D plane.

The thus produced 2D image DP is displayed on a liquid crystal panel 1 as shown in FIG. 1A.

Laser light L1 that is output from a predetermined light source and is converted into e.g. parallel light passes through the liquid crystal panel 1 on which the 2D image DP is displayed, to thereby be turned into object light L2 as the image of the 2D image DP.

The object light L2 is condensed by a condenser lens 2 so as to be converged on the hologram memory 3 as a spot.

At this time, the hologram memory 3 is irradiated with recording reference light L3 from a predetermined angle. Thus, the object light L2 and the reference light L3 interfere with each other, so that a dot element hologram is recorded based on an interference fringe due to the light interference.

When the condenser lens 2 is used in this manner, data to be recorded as an element hologram is converted into the Fourier image of the image of the record data due to the Fourier transform operation of the condenser lens 2.

One element hologram is recorded in the hologram memory 3 in this manner. Furthermore, sequentially the respective data blocks BLK of FIG. 2A are converted into the 2D images DP and displayed on the liquid crystal panel 1 so as to be recorded as element holograms in a similar manner.

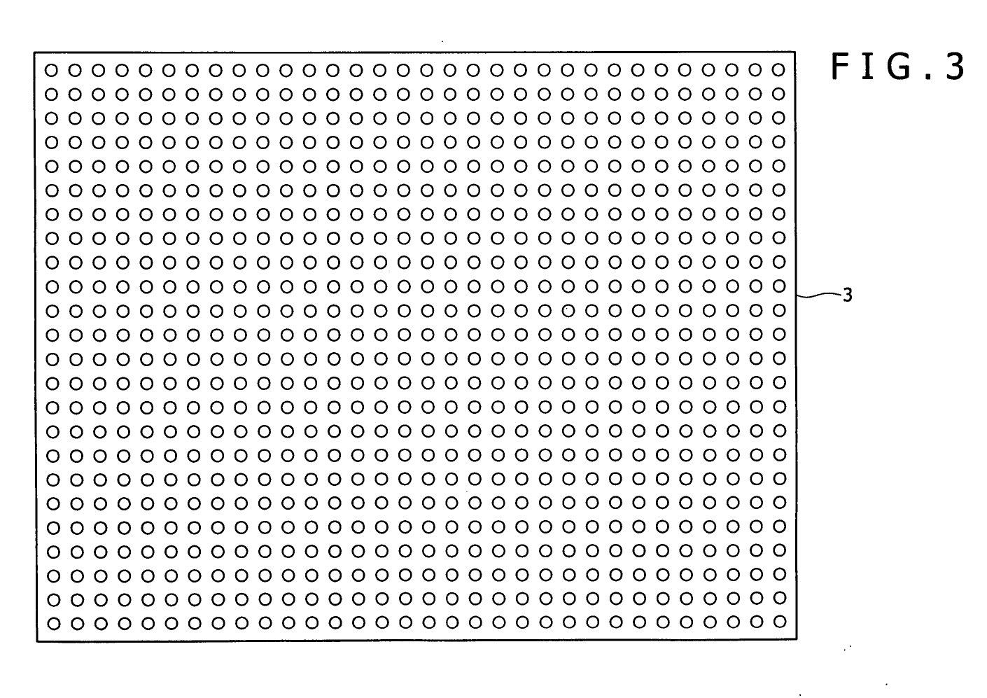

In the recording of the respective element holograms, the position of the hologram memory 3 (hologram material) is varied (or the recording optical system is transferred) with use of a transfer mechanism (not shown) so that the recording positions of the element holograms are shifted from each other by a slight distance on the plane of the hologram memory 3. Thus, recording in the hologram memory 3 having e.g. a sheet shape is executed so that a large number of element holograms are arranged in planar directions of the hologram memory 3. As shown in FIG. 3, in which one element hologram is expressed by a circle, a large number of element holograms are formed on a plane.

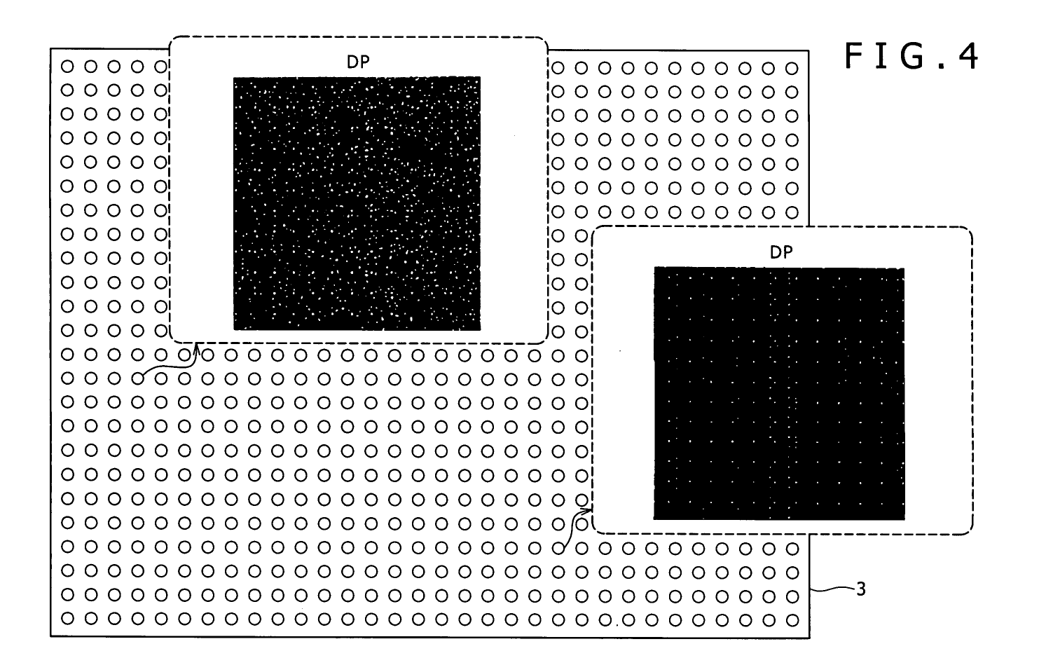

FIG. 3 illustrates an example in which thirty-two element holograms are arranged along the horizontal direction and twenty-four element holograms are arranged along the vertical direction on the plane of the hologram memory 3. In each of the element holograms, the 2D image DP is recorded as shown in FIG. 4.

Reproduction from the hologram memory 3 in which element holograms have been thus recorded is carried out as shown in FIG. 1B. A collimator lens 11 and an imager 12 shown in FIG. 1B are elements provided in a reproducing device as a hologram reader.

Reproduction reference light L4 is emitted to the hologram memory 3 from the same radiation angle as that in the recording. This irradiation with the reproduction reference light L4 allows achievement of the reproduced image of data recorded as an element hologram. That is, the image of 2D page data appears at the place in conjugation with the liquid crystal panel 1 in the recording. This image is read through the imager 12.

Specifically, reproduced-image light L5 from the hologram memory 3 is converted into parallel light by the collimator lens 11, and then enters the imager 12 formed of e.g. a CCD imaging element array or CMOS imaging element array. A Fourier image on the hologram memory 3 is subjected to the inverse Fourier transform by the collimator lens 11 to thereby be converted into the image of 2D page data, and hence a reproduced image as this 2D image DP is read by the imager 12.

The imager 12 produces a 2D image signal as an electric signal dependent upon the reproduced image. Decoding processing for the 2D image signal results in achievement of the original data, i.e., the element hologram record data DT same as the data originally existing before the conversion thereof into the 2D image DP for the recording. That is, one data block BLK included in content data is obtained.

By similarly implementing data reading for a large number of element holograms on the hologram memory 3, the respective data blocks BLK are read, so that the original content data or the like recorded in the hologram memory 3 can be restored.

The hologram memory 3, in which data is recorded as element holograms as described above, can be easily mass-replicated through contact copy.

Therefore, although the hologram memory 3 in which element holograms are recorded on a hologram material as shown in FIG. 1A may be used directly as a hologram memory to be provided to a general user, it may also be used as a master medium and be used for mass-replication of hologram memories through contact copy.

For example, in a system in which computer data, AV content data or the like is recorded in the hologram memories 3 to be widely distributed, and a general user can acquire data recorded in the hologram memory 3 with use of a reproducing device (hologram reader 6), it is preferable that a hologram master medium be produced as shown in FIG. 1A so that hologram memories replicated from the master medium are distributed, and data be read out through the operation shown in FIG. 1B on the user side.

The hologram reader 6 as a reproducing device of an embodiment of the invention to be described later implements scanning for reading the respective element holograms through emission of the reproduction reference light L4 to the hologram memory 3. As the scanning system, a manual scanning system in which a user executes the scanning and an automatic scanning system in which the hologram reader 6 mechanistically executes the scanning are possible.

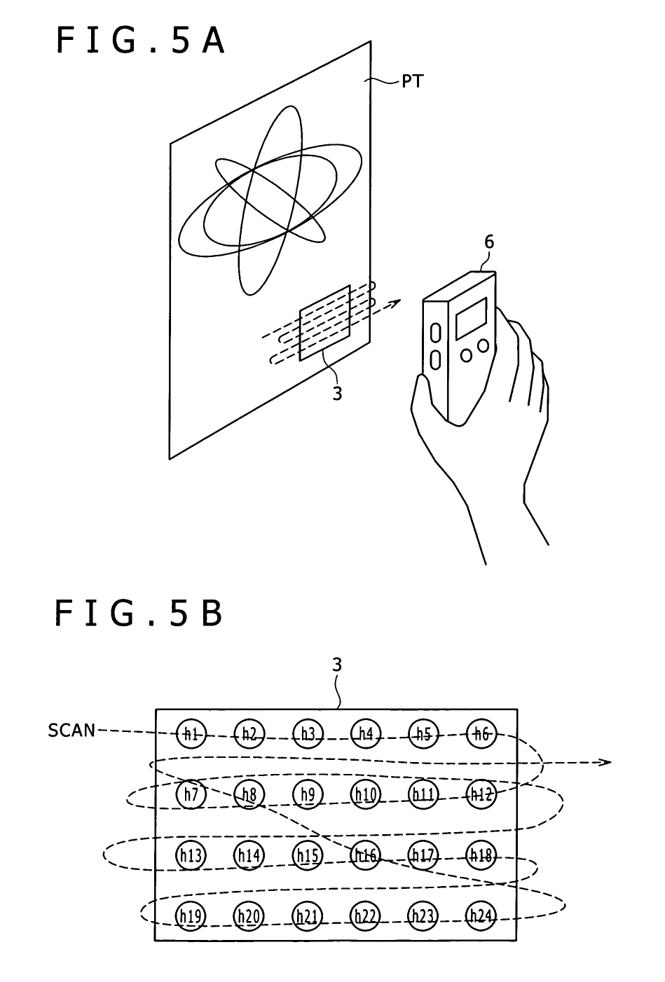

FIG. 5A illustrates an example of the manual scanning system. Specifically, FIG. 5A shows as one example a state where the hologram memory 3 in which data such as audio content data is recorded is attached to a poster PT or the like. The hologram reader 6 is an apparatus that is so small and light that a user can hold the reader 6 by hand. On one face of the case of the hologram reader 6, a light source that outputs the above-described reproduction reference light L4 and a lens system for capturing reproduced-image light from the hologram memory 3 are formed.

A user holds the hologram reader 6 as shown in the drawing and brings the reader 6 close to the hologram memory 3 so that the one face of the case of the reader 6 faces the memory 3. In this state, the user swings the hologram reader 6 in any directions optionally. During the swinging, the reproduced images of element holograms irradiated with the reproduction reference light L4 from a predetermined angle are read by the hologram reader 6.

FIG. 5A shows an example in which a user swings the hologram reader 6 with keeping the reader 6 apart from the hologram memory 3. However, another scanning system would also be available in which the hologram reader 6 is swung vertically and laterally with part of the case thereof being brought into contact with the surface of the hologram memory 3, i.e., the reader 6 is slid on the memory 3.

FIG. 5B schematically shows the hologram memory 3 in which a large number of element holograms h1 to h24 are recorded. When a user swings the hologram reader 6 in e.g. the left and right directions at random, the trajectory of the reading-out scanning for the hologram memory 3 (trajectory of the spot of the reproduction reference light L4) is expressed by the dashed line in FIG. 5B.

Since how a user actually moves the hologram reader 6 is not definite at all, the element holograms on the hologram memory 3 are irradiated with the spot of the reproduction reference light L4 completely irregularly and unstably. In this state, the reproduced images of the element holograms irradiated with the spot of the reproduction reference light L4 are read by the hologram reader 6. That is, the reading out of the respective element holograms h1 to h24 is stochastic. The hologram reader 6 sequentially decodes the read element holograms and accumulates the decoded data, so that the hologram reader 6 reconstructs the reproduced data when the decoding of the requisite amount of the data has been completed.

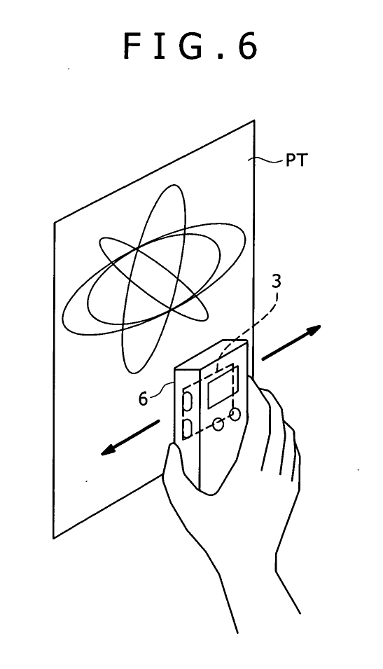

In contrast, in the automatic scanning system, the hologram reader 6 moves the emission position of the reproduction reference light L4 or moves the unit holding the collimator lens 11 and the imager 12 due to the operation of a scanning mechanism inside the reader 6, to thereby sequentially read element holograms on the hologram memory 3. For example, it would be possible to execute automatic scanning in a state where the hologram reader 6 is placed to face the hologram memory 3 attached to a poster or the like as shown in FIG. 6. Specifically, in this case, it is sufficient for a user to merely keep the hologram reader 6 in front of the hologram memory 3, and the movement of the emission position of the reproduction reference light L4 or the lens system due to the scanning mechanism leads to the scanning of element holograms on the hologram memory 3.

Alternatively, another system would also be available in which a medium in a form of being attached to a card base is used as the sheet hologram memory 3 and this memory 3 is loaded in the hologram reader 6, so that scanning operation is carried out in the hologram reader 6 to thereby read element holograms.

[2. Recording Configuration of Element Hologram]

The recording configuration of each element hologram recorded on the hologram memory 3 will be described below.

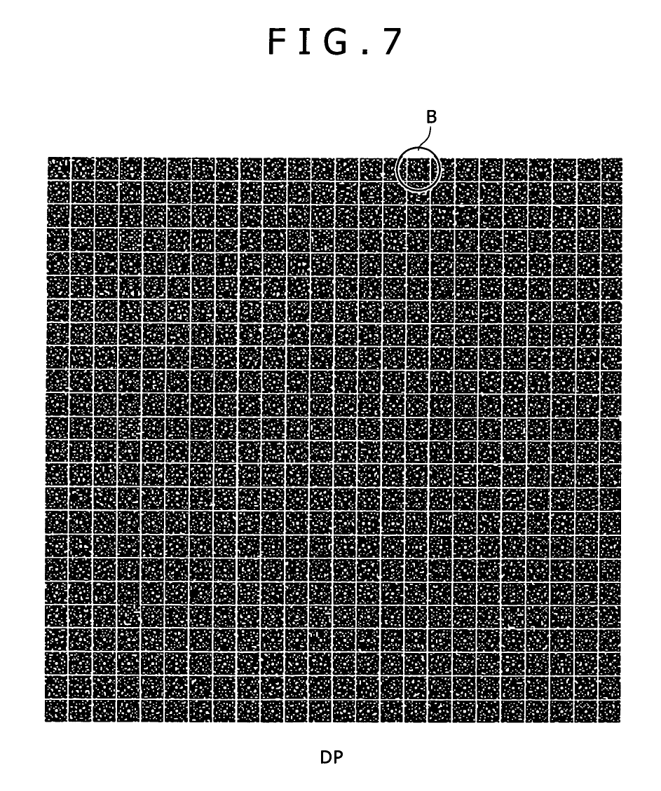

FIG. 7 shows an example of the 2D image DP recorded as one element hologram. More specifically, FIG. 7 shows an example in which the 2D image DP is formed of pixel blocks B of vertical 24 blocks by horizontal 24 blocks.

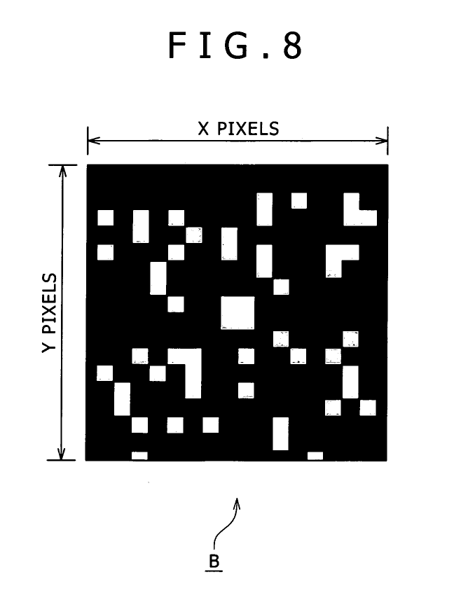

One pixel block B includes pixels of X pixels by Y pixels as shown in FIG. 8 for example. FIG. 8 shows an example in which X=Y=16, i.e., the pixel block B is formed of 16×16 pixels.

In each pixel block B, unit data included in the element hologram record data DT is recorded as shown in FIG. 2E. In e.g. one pixel block B01, the unit data including the data DT01 and the unit data address Ad01 is converted into a 2D pattern like the example of FIG. 8.

As described above, the 2D image DP, which is recorded as an element hologram, is formed of assembly of the pixel blocks B each representing unit data.

In one element hologram, the element hologram record data DT like that in FIG. 2B is recorded. The element hologram record data DT is composed of plural unit data as shown in FIG. 2E.

In the hologram memory 3 of the present embodiment, in the 2D image DP recorded as an element hologram, an inside area and an outer peripheral area that surrounds the inside area are defined. The inside area is configured to contain all of the unit data included in the element hologram record data DT, and the outer peripheral area is configured to contain all or part of the unit data.

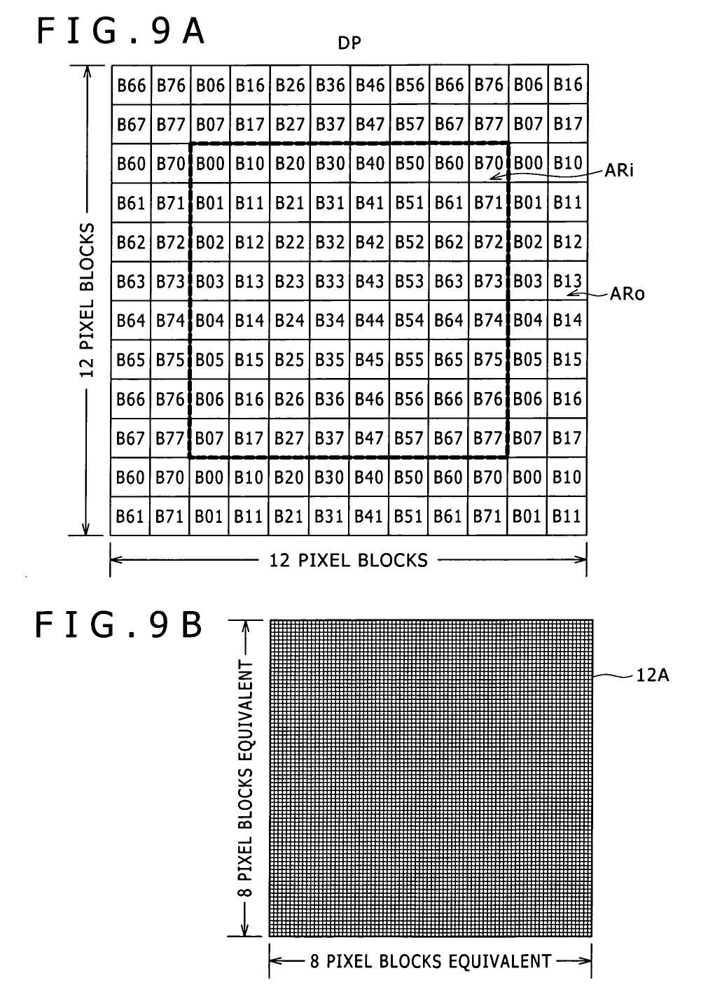

Examples of such a 2D image DP will be described below with reference to FIGS. 9A and 9B and subsequent drawings.

Note that in FIGS. 9A and 9B and subsequent drawings, one 2D image DP is formed of 12×12 pixel blocks for simplification of descriptions and illustrations.

FIG. 9A shows a configuration example of the 2D image DP.

In this 2D image DP, the region inside the dashed line is defined as an inside area ARi, while the surrounding part outside the dashed line is defined as an outer peripheral area ARo.

The inside area ARi is defined as the region that corresponds to an effective imaging pixel area 12A in an imaging element unit 12 of a reproducing device (hologram reader 6) to be described later for reading out data from the hologram memory 3.

FIG. 9B illustrates an example of the effective imaging pixel area 12A in the imaging element unit 12 formed of a CCD or CMOS imaging sensor array. In this example, the effective imaging pixel area 12A is equivalent to the region of eight pixel blocks by eight pixel blocks.

In this case, the center area of eight pixel blocks by eight pixel blocks in the 2D image DP is defined as the inside area ARi.

The example of FIG. 9A is based on an assumption that the element hologram record data DT to be converted into the 2D image DP and be recorded as an element hologram is composed of the unit data DT00 to DT77 (DT00 . . . DT07, DT10 . . . DT17, DT20 . . . DT27, DT30 . . . DT37, DT40 . . . DT47, DT50 . . . DT57, DT60 . . . DT67, and DT70 . . . DT77).

That is, the relationship that the element hologram record data DT=the unit data DT00+DT01+DT02+ . . . +DT77 is satisfied.

In this example, the pixel blocks B in which the unit data DT00 to DT77 (including the unit data addresses Ad00 to Ad77) are converted into the respective 2D patterns are expressed as the pixel blocks B00 to B77, respectively (B00 . . . B07, B10 . . . B17, B20 . . . B27, B30 . . . B37, B40 . . . B47, B50 . . . B57, B60 . . . B67, and B70 . . . B77).

For example, the unit data DT00 and the unit data address Ad00 are converted into a 2D pattern in the pixel block B00.

As shown in FIG. 9A, in the 2D image DP, the inside area ARi includes one of each of the pixel blocks B00 to B77.

Furthermore, in the outer peripheral area ARo, predetermined pixel blocks of the pixel blocks B00 to B77 are disposed at predetermined positions.

For example, the pixel blocks B00 . . . B07 and B10 . . . B17 arranged on the leftmost two columns in the inside area ARi are arranged also on the right two columns in the outer peripheral area ARo.

The pixel blocks B60 . . . B67 and B70 . . . B77 arranged on the rightmost two columns in the inside area ARi are arranged also on the left two columns in the outer peripheral area ARo.

The pixel blocks B00, B10, B20, . . . B70, B01, B11, B21, . . . B71 arranged on the uppermost two rows in the inside area ARi are arranged also on the lower two rows in the outer peripheral area ARo.

The pixel blocks B06, B16, B26, . . . B76, B07, B17, B27, . . . B77 arranged on the lowermost two rows in the inside area ARi are arranged also on the upper two rows in the outer peripheral area ARo.

In this manner, the pixel blocks of all the unit data included in the element hologram record data DT are arranged in the inside area ARi. In addition, the pixel blocks of part of the unit data are arranged also in the outer peripheral area ARo.

In most cases, such a 2D image DP allows the imaging element unit 12 of the hologram reader 6 to capture the pixel blocks B00 to B77 (i.e., images of the unit data DT00 to DT77) without block deficiency as imaging signals in the effective imaging pixel area 12A.

When the 2D image of an element hologram is imaged with no geometric misalignment, the inside area ARi of FIG. 9A is imaged by the imaging element unit 12 in the effective imaging pixel area 12A of FIG. 9B. In this case, the imaging signals of the pixel blocks B00 to B77 can be obtained without any problem.

However, when e.g. the above-described manual scanning is employed in particular, the reproduced-image light of the 2D image DP is imaged on the imaging element unit 12 in a state where a geometric misalignment has occurred due to impossibility to specify the accuracy of the scanning position with respect to the element hologram and camera-shake, and depending on the direction along which the user makes the hologram reader 6 face the hologram memory 3, and so on. Note that the automatic scanning also involves the possibility of occurrence of a geometric misalignment. The types of the geometric misalignments include misalignments in the vertical direction, misalignments in the horizontal direction, and misalignments in the rotational direction (hereinafter, sometimes referred to as vertical misalignments, horizontal misalignments, and rotational misalignments, respectively).

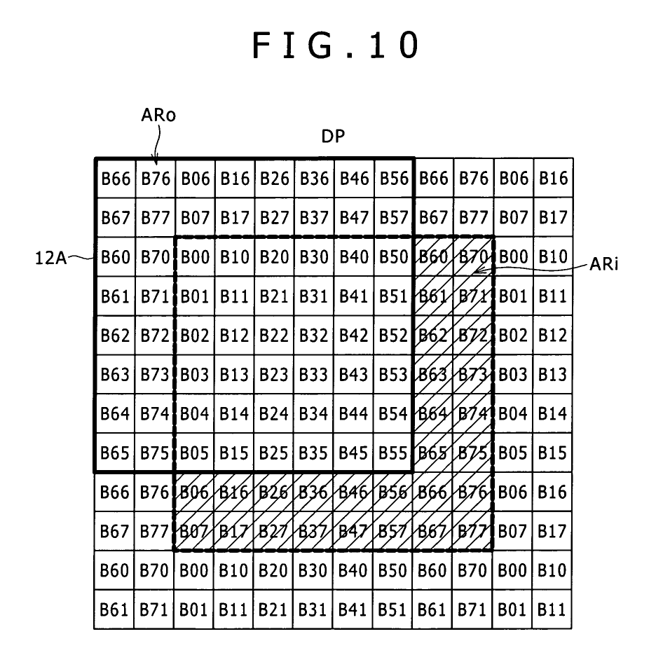

FIG. 10 shows a state where a vertical misalignment and a horizontal misalignment have occurred in a complex manner.

In FIG. 10, the region indicated by the full-line frame corresponds to the area imaged through the effective imaging pixel area 12A of the imaging element unit 12.

In this case, a part of the pixel blocks in the inside area ARi cannot be read. Specifically, the pixel blocks B06, B07, B16, B17 . . . in the hatched area cannot be read. However, these hatched pixel blocks are arranged also in the outer peripheral area ARo, and thus all the pixel blocks same as the hatched blocks are included in the effective imaging pixel area 12A. That is, even when the 2D image DP is imaged on the imaging element unit 12 in a state where a geometric misalignment in the vertical and horizontal directions has occurred like in FIG. 10, the pixel blocks B00 to B77 can be captured without block deficiency, and thus the unit data DT00 to DT77 can be obtained through decoding processing for the respective pixel blocks.

In the case of the pixel block arrangement of this example, even when a misalignment in any direction other than that in FIG. 10 has occurred as a vertical misalignment, a horizontal misalignment, or a vertical and horizontal misalignment, the pixel blocks B00 to B77 can be captured without block deficiency, although not shown in the drawing.

Therefore, the decoded data of the element hologram record data DT can be obtained from the element hologram adequately.

However, when the pixel block arrangement shown in FIG. 9A is employed, there is a possibility that part of the pixel blocks B00 to B77 cannot be imaged due to a rotational misalignment.

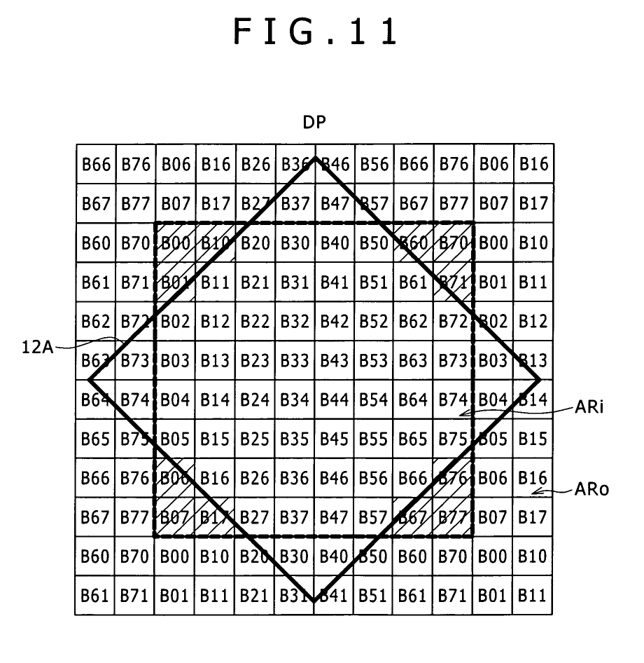

FIG. 11 shows an example of the rotational misalignment. Specifically, FIG. 11 shows a state where a misalignment of a rotation angle of 45 degrees has occurred as the case of occurrence of the largest rotational misalignment. In this case, the effective imaging pixel area 12A and the 2D image DP have the positional relationship therebetween shown in FIG. 11. In this relationship, twelve pixel blocks B00, B01, B10, B06, B07, B17, B60, B70, B71, B67, B76, and B77 in the hatched region in the inside area ARi cannot be imaged. Furthermore, these twelve pixel blocks are not the pixel blocks that are included in the outer peripheral area ARo and can be imaged. Accordingly, the imaging is executed with these twelve pixel blocks being missing.

Even when part of the pixel blocks B00 to B77 cannot be captured, i.e., part of the unit data DT00 to DT77 is absent, the missing data can be restored through error correction processing in decoding as long as the number of the missing unit data is small. Specifically, due to error correction processing with use of the error correction parity included in the element hologram record data DT shown in FIG. 2B, the missing unit data can be restored. However, it should be obvious that the amount of the missing unit data that can be restored is limited within the range the set error correction ability can cover.

Therefore, even in the case of FIG. 11, the unit data DT00 to DT77 can be restored adequately and thus the element hologram record data DT can be achieved depending on the error correction ability in some cases. However, it is desirable that the number of the missing data be as small as possible of course.

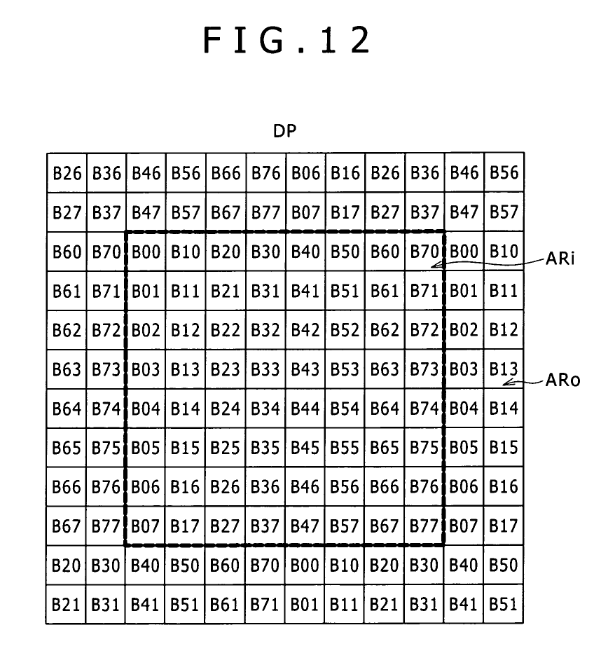

FIG. 12 shows an example of the block arrangement that allows the number of missing unit data to be as small as possible even when a rotational misalignment has occurred.

In the example of FIG. 12, the pixel blocks B00 to B77 are arranged in the inside area ARi similarly to FIG. 9A.

Furthermore, in the outer peripheral area ARo, predetermined pixel blocks of the pixel blocks B00 to B77 are disposed at predetermined positions as shown in the drawing.

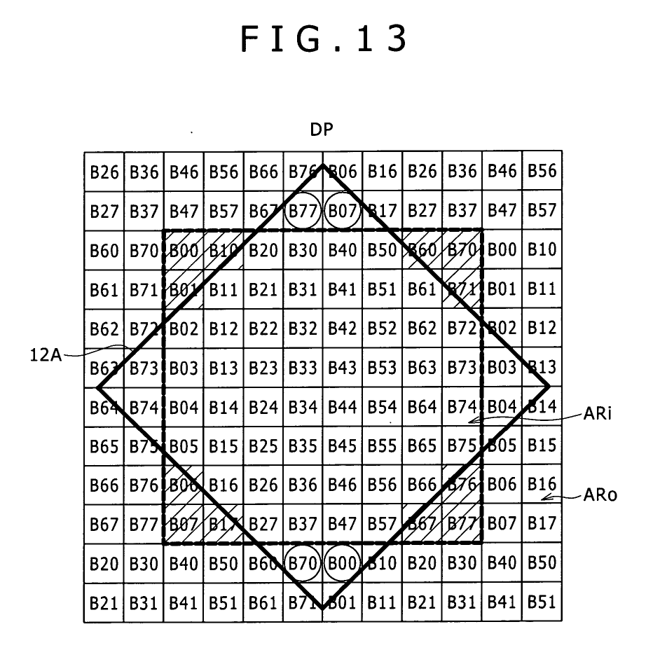

FIG. 13 shows a state where a rotational misalignment of an angle of 45 degrees has occurred similarly to FIG. 11 when the block arrangement of FIG. 12 is employed. In this state, similarly to FIG. 11, twelve pixel blocks B00, B01, B10, B06, B07, B17, B60, B70, B71, B67, B76, and B77 in the hatched region in the inside area ARi cannot be imaged.

However, of these pixel blocks, the pixel blocks B77, B70, B07 and B00 are the pixel blocks that exist in the outer peripheral area ARo and can be imaged as indicated by the circles in the drawing.

That is, in this example, of twelve pixel blocks that exist in the inside area ARi and are not covered by the effective imaging pixel area 12A, four pixel blocks can be captured from the outer peripheral area ARo. Therefore, even when the largest rotational misalignment has occurred, the amount of missing unit data can be decreased, which can enhance the possibility that the decoded data of the element hologram record data DT can be correctly obtained through error correction processing.

A description will be made below on an example in which unit data can be imaged without deficiency even when any of a vertical misalignment, a horizontal misalignment and a rotational misalignment has occurred, or a complex misalignment of these misalignments has occurred.

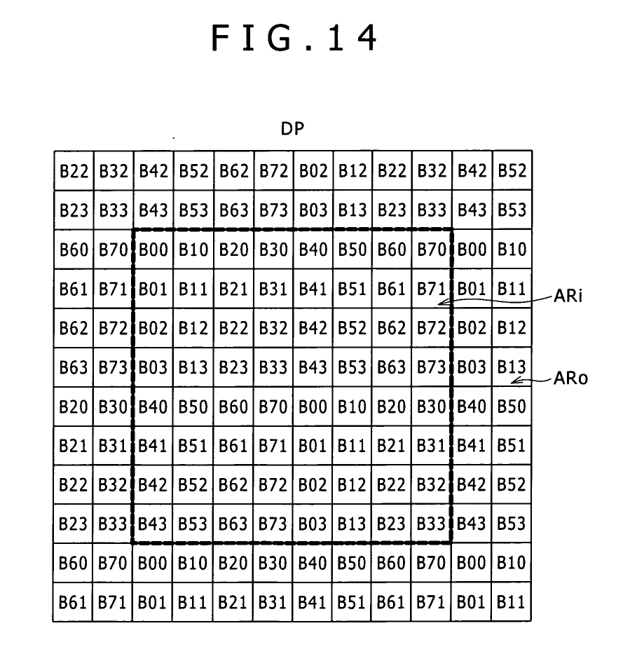

In this example, the inside area ARi is configured to contain a plurality of each of all the unit data included in element hologram record data. FIG. 14 shows the example.

The example of FIG. 14 is based on an assumption that the element hologram record data DT to be converted into the 2D image DP and be recorded as an element hologram is composed of the unit data DT00 to DT73 (DT00 . . . DT03, DT10 . . . DT13, DT20 . . . DT23, DT30 . . . DT33, DT40 . . . DT43, DT50 . . . DT53, DT60 . . . DT63, and DT70 . . . DT73).

That is, the relationship that the element hologram record data DT=the unit data DT00+DT01+DT02+ . . . +DT73 is satisfied.

Similarly to the above-described examples, in this example, the pixel blocks B in which the unit data DT00 to DT73 (including the unit data addresses Ad01 to Ad73) are converted into the respective 2D patterns are expressed as the pixel blocks B00 to B73, respectively (B00 . . . B03, B10 . . . B13, B20 . . . B23, B30 . . . B33, B40 . . . B43, B50 . . . B53, B60 . . . B63, and B70 . . . B73).

As shown in FIG. 14, in the 2D image DP, the inside area ARi includes two of each of the pixel blocks B00 to B73.

Specifically, the pixel blocks B00 to B73 are arranged on four rows in the upper half of the inside area ARi, and the pixel blocks B00 to B73 are arranged also on four rows in the lower half thereof. As is apparent from the drawing, the same pixel blocks are arranged in each of the upper half and the lower half with the positions of the blocks being shifted from each other by four columns between the upper and lower halves: the pixel blocks B00 to B03 are arranged on the first column of the upper four rows and on the fifth column of the lower four rows, the pixel blocks B10 to B13 on the second column of the upper four rows and on the sixth column of the lower four rows, the pixel blocks B20 to B23 on the third column of the upper four rows and on the seventh column of the lower four rows, and so on.

Furthermore, in the outer peripheral area ARo, all of the pixel blocks B00 to B73 are disposed at predetermined positions.

For example, the pixel blocks B00 . . . B03, B40 . . . B43, B10 . . . B13 and B50 . . . B53 arranged on the leftmost two columns in the inside area ARi are arranged also on the right two columns in the outer peripheral area ARo.

The pixel blocks B60 . . . B63, B20 . . . B23, B70 . . . B73 and B30 . . . B33 arranged on the rightmost two columns in the inside area ARi are arranged also on the left two columns in the outer peripheral area ARo.

The pixel blocks B00, B10, B20, . . . B70, B01, B11, B21, . . . B71 arranged on the uppermost two rows in the inside area ARi are arranged also on the lower two rows in the outer peripheral area ARo.

The pixel blocks B42, B52, B62, . . . B32, B43, B53, B63, . . . B33 arranged on the lowermost two rows in the inside area ARi are arranged also on the upper two rows in the outer peripheral area ARo.

The pixel blocks B00, B01, B10 and B11 arranged at the upper left corner in the inside area ARi are arranged also at the lower right corner in the outer peripheral area ARo.

The pixel blocks B60, B61, B70 and B71 arranged at the upper right corner in the inside area ARi are arranged also at the lower left corner in the outer peripheral area ARo.

The pixel blocks B42, B43, B52 and B53 arranged at the lower left corner in the inside area ARi are arranged also at the upper right corner in the outer peripheral area ARo.

The pixel blocks B22, B23, B32 and B33 arranged at the lower right corner in the inside area ARi are arranged also at the upper left corner in the outer peripheral area ARo.

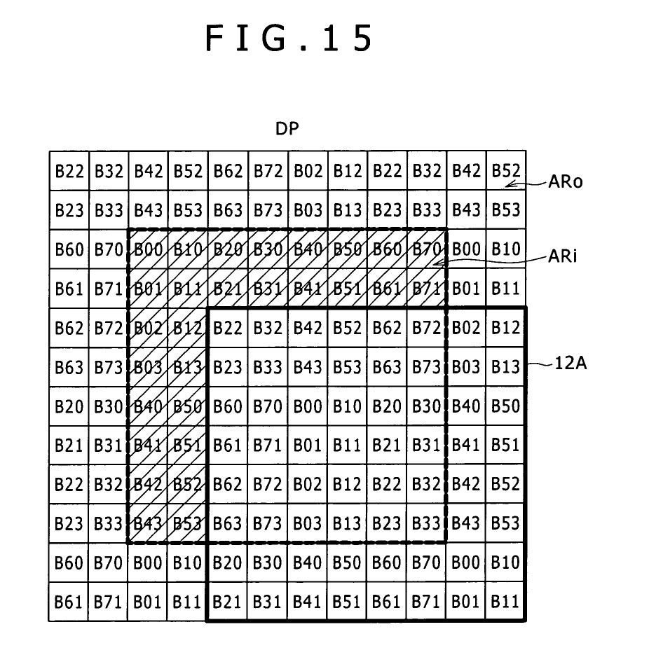

FIG. 15 shows a state where a vertical misalignment and a horizontal misalignment have occurred in a complex manner when this block arrangement example is employed.

In this case, the hatched pixel blocks B00, B01, B02, B03 . . . in the inside area ARi cannot be read. However, these hatched pixel blocks are arranged also in the outer peripheral area ARo, and thus all the pixel blocks same as the hatched blocks are included in the effective imaging pixel area 12A. That is, even when the 2D image DP is imaged on the imaging element unit 12 in a state where a geometric misalignment in the vertical and horizontal directions has occurred like in FIG. 15, the pixel blocks B00 to B73 can be captured without block deficiency, and thus the unit data DT00 to DT73 can be obtained through decoding processing for the respective pixel blocks. Even when any of a vertical misalignment, a horizontal misalignment and a vertical and horizontal misalignment in any other direction (not shown) has occurred, the pixel blocks B00 to B73 can be imaged without block deficiency.

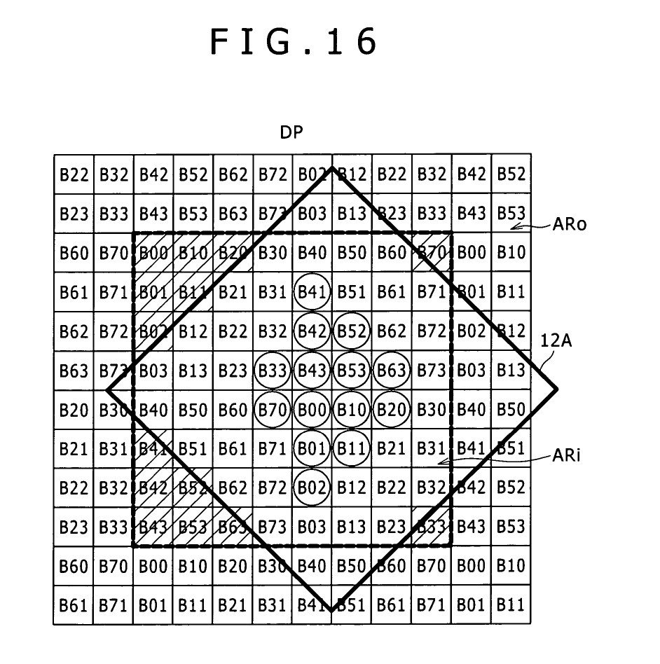

Furthermore, an example in which a 45-degree rotational misalignment and a horizontal misalignment have occurred in a complex manner is shown in FIG. 16.

In this case, as is apparent from the drawing, fourteen pixel blocks B00, B01, B02, B10, B11, B20, B41, B42, B43, B52, B53, B63, B70 and B33 in the hatched region in the inside area ARi cannot be imaged.

However, these pixel blocks are the same as the blocks that exist in the inside area ARi and can be imaged as indicated by the circles in the drawing. That is, even when a rotational misalignment has occurred like in FIG. 16, the pixel blocks B00 to B73 can be captured without block deficiency, and thus the unit data DT00 to DT73 can be obtained through decoding processing for the respective pixel blocks.

Specifically, in this example, the pixel blocks that cannot be read from the inside area ARi when a misalignment in the vertical and horizontal directions has occurred can be covered by the same pixel blocks arranged in the outer peripheral area ARo. In addition, the pixel blocks that cannot be read from the inside area ARi when a rotational misalignment has occurred can be covered by the other same pixel blocks arranged in the inside area ARi.

This block arrangement offers a high possibility that all unit data can be decoded compatibly with almost all geometric misalignments within the range of the 2D image DP, and thus allows adequate decoding of the element hologram record data DT from an element hologram.

Further another example will be described below.

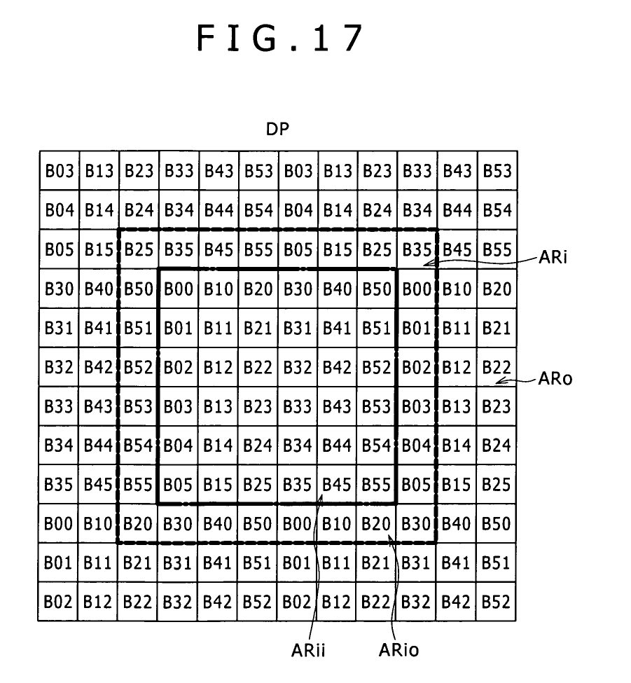

FIG. 17 shows this example. In the example, the inside area ARi is further divided into a center area ARii and a surrounding area ARio, and is configured so that all unit data included in element hologram record data are contained in the center area ARii and all or part of the unit data is included also in the surrounding area ARio.

As described above, the inside area ARi corresponds to the effective imaging pixel area 12A. This inside area ARi is divided into the center area ARii and the surrounding area ARio as indicated by the dot-and-dash line in FIG. 17.

The example of FIG. 17 is based on an assumption that the element hologram record data DT to be converted into the 2D image DP and be recorded as an element hologram is composed of the unit data DT00 to DT55 (DT00 . . . DT05, DT10 . . . DT15, DT20 . . . DT25, DT30 . . . DT35, DT40 . . . DT45, and DT50 . . . DT55). That is, the relationship that the element hologram record data DT=the unit data DT00+DT01+DT02+ . . . +DT55 is satisfied.

Similarly to the above-described examples, in this example, the pixel blocks B in which the unit data DT00 to DT55 (including the unit data addresses Ad01 to Ad55) are converted into the respective 2D patterns are expressed as the pixel blocks B00 to B55, respectively (B00 . . . B05, B10 . . . B15, B20 . . . B25, B30 . . . B35, B40 . . . B45, and B50 . . . B55).

As shown in FIG. 17, in the 2D image DP, the center area ARii in the inside area ARi includes one of each of the pixel blocks B00 to B55.

In the surrounding area ARio, the pixel blocks arranged in the peripheral part of the center area ARii are disposed at predetermined positions.

Specifically, the pixel blocks B00, B10, B20, B30, B40 and B50 arranged on the uppermost one row in the center area ARii are arranged also on the lower side of the surrounding area ARio.

The pixel blocks B05, B15, B25, B35, B45 and B55 arranged on the lowermost one row in the center area ARii are arranged also on the upper side of the surrounding area ARio.

The pixel blocks B50, B51, B52, B53, B54 and B55 arranged on the rightmost one column in the center area ARii are arranged also on the left side of the surrounding area ARio.

The pixel blocks B00, B01, B02, B03, B04 and B05 arranged on the leftmost one column in the center area ARii are arranged also on the right side of the surrounding area ARio.

In the outer peripheral area ARo, the pixel blocks are arranged in such a manner that the arrangement relationship between the center area ARii and the surrounding area ARio is directly extended outward.

Specifically, the pixel blocks arranged on the lowermost three rows in the center area ARii are disposed at predetermined positions on the uppermost three rows in the 2D image DP, including the outer peripheral area ARo and the surrounding area ARio.

The pixel blocks arranged on the uppermost three rows in the center area ARii are disposed at predetermined positions on the lowermost three rows in the 2D image DP, including the outer peripheral area ARo and the surrounding area ARio.

The pixel blocks arranged on the rightmost three columns in the center area ARii are disposed at predetermined positions on the leftmost three columns in the 2D image DP, including the outer peripheral area ARo and the surrounding area ARio.

The pixel blocks arranged on the leftmost three columns in the center area ARii are disposed at predetermined positions on the rightmost three columns in the 2D image DP, including the outer peripheral area ARo and the surrounding area ARio.

In other words, it can be said that the area containing one of each of unit data, which is the inside area ARi in the examples of e.g. FIG. 9A and FIG. 12, is set as the center area ARii smaller than the effective imaging pixel area 12A of the imaging element unit 12.

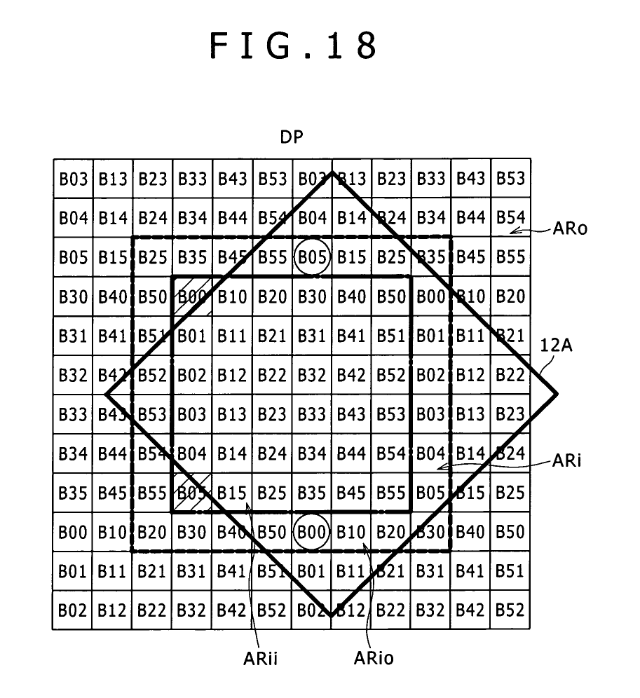

FIG. 18 shows a state where a 45-degree rotational misalignment and a horizontal misalignment have occurred in a complex manner when this arrangement example is employed.

As is apparent from the drawing, the hatched pixel blocks B00 and B05 in the center area ARii cannot be imaged.

However, these pixel blocks B00 and B05 are the same as the blocks that exist in the surrounding area ARio and can be imaged as indicated by the circles in the drawing. That is, even when a rotational misalignment has occurred, the pixel blocks B00 to B55 can be captured without block deficiency, and thus the unit data DT00 to DT55 can be obtained through decoding processing for the respective pixel blocks.

This block arrangement can also favorably address almost all other geometric misalignments, although not shown in the drawing.

In addition, most of the pixel blocks can be imaged as the pixel blocks in the center area ARii. Therefore, it can be said that this block arrangement originally has robust readiness capability against geometric misalignments.

This block arrangement offers a very high possibility that all unit data can be decoded compatibly with almost all geometric misalignments within the range of the 2D image DP, and thus allows adequate decoding of the element hologram record data DT from an element hologram.

In the above-described examples of FIGS. 9A, 12, 14 and 17, the pixel blocks that cannot be imaged from the inside area ARi or the center area ARii can be covered by the other same pixel blocks. In addition, in the examples, a plurality of the same pixel blocks are frequently read. When a certain read pixel block has suffered from a decoding error due to any cause for example, if the other same pixel block has been read, the other same pixel block can be decoded adequately in some cases. This point also offers advantages in terms of achievement of favorable decoding results.

[3. Configuration of Hologram Reader]

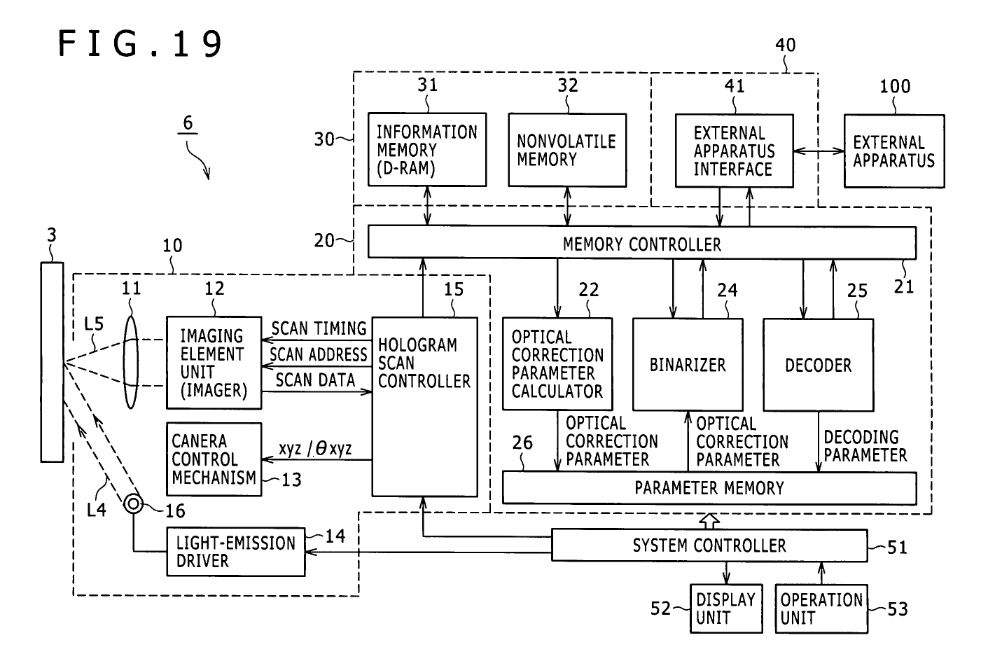

The configuration of the hologram reader 6 (hologram reproducing device) of the embodiment will be described below with reference to FIG. 19.

The hologram reader 6 includes four blocks: an imaging part 10, a signal processing part 20, a memory part 30, and an external apparatus IF part 40. These respective parts implement requisite operation based on control by a system controller 51.

The system controller 51 is formed of e.g. a microcomputer, and controls the respective parts in order to execute operation of reading data from the hologram memory 3.

Furthermore, the system controller 51 monitors operation information of an operation unit 53, and implements requisite control in response to user's operation. In addition, the system controller 51 controls a display unit 52 so that the display unit 52 displays various kinds of information to be provided to a user.

The imaging part 10 is a block for capturing 2D images reproduced from element holograms on the hologram memory 3, and includes a collimator lens 11, an imaging element unit (imager) 12, a camera control mechanism 13, a light-emission driver 14, a hologram scan controller 15, and a reference light source 16.

The collimator lens 11 and the imaging element unit 12 are equivalent to the collimator lens 11 and the imager 12 described with FIG. 1B. The imaging element unit 12 is a device such as a CMOS image sensor or CCD image sensor for detecting 2D images.

The camera control mechanism 13 is a device for controlling the positional relationship between the imaging element unit 12 (or the reference light source 16) and the hologram memory 3, and has a function of manually or automatically controlling a movable part. If a manual scanning system like one described with FIG. 5 or 6 is employed, this camera control mechanism 13 is unnecessary.

The reference light source 16 is disposed on the case of the hologram reader 6 so as to emit the reproduction reference light L4 to the hologram memory 3 from the same angle as that of the recording reference light L3 in the recording shown in FIG. 1A. The reference light source 16 formed of e.g. a light emitting diode (LED) or semiconductor laser is driven by the light-emission driver 14 to emit light. When reproduction from the hologram memory 3 is carried out by the hologram reader 6, the light-emission driver 14 drives the reference light source 16 to emit light in accordance with an instruction from the system controller 51.

The hologram scan controller 15 determines the imaging timing in hologram scanning and pixels to be read out based on the condition of a 2D image read by the imaging element unit 12 and the past scanning status stored in a parameter memory 26, and supplies the imaging element unit 12 with a scan timing signal and a scan address signal to thereby control the imaging operation of the imaging element unit 12. Furthermore, the hologram scan controller 15 executes processing for 2D image signals obtained by the imaging element unit 12.

The signal processing part 20 is a block for executing signal processing for a series of 2D images captured by the imaging part 10, and includes a memory controller 21, an optical correction parameter calculator 22, a binarizer 24, a decoder 25, and the parameter memory 26.

The memory controller 21 assures arbitration of data reading/writing between the memory part 30 and each of the hologram scan controller 15, the optical correction parameter calculator 22, the binarizer 24, and the decoder 25.

The optical correction parameter calculator 22 detects the status of luminance variation in a 2D image and determines an optical correction parameter.

The binarizer 24 binarizes the 2D image based on the optical correction parameter.

The decoder 25 decodes the data binarized by the binarizer 24 to thereby reproduce the information read out from the hologram memory 3.

The parameter memory 26 stores therein the optical correction parameter calculated by the optical correction parameter calculator 22.

The memory part 30 is a device that has a function of storing 2D images transferred from the hologram scan controller 15, a function of storing an intermediate result of signal processing executed by the signal processing part 20, and a function of storing information decoded by the decoder 25. The memory part 30 includes an information memory 31 and a nonvolatile memory 32.

The information memory 31 is formed of e.g. a dynamic random access memory (DRAM), and serves as a storage area that stores therein 2D images transferred from the hologram scan controller 15. The stored 2D images are retrieved for processing in the optical correction parameter calculator 22 and the binarizer 24.

The nonvolatile memory 32 serves as a storage area for information decoded by the decoder 25, specifically, for e.g. audio/video information as the element hologram record data DT read out from element holograms.

The external apparatus IF part 40 is a device that transmits audio/video information or the like read out by the hologram reader 6 to an external apparatus 100, and includes an external apparatus interface 41.

The operation of the respective units when data is read out from the hologram memory 3 will be described below.

When scanning for the hologram memory 3 is carried out, the light-emission driver 14 drives the reference light source 16 to emit light. The reproduced-image light of an element hologram is obtained from the hologram memory 3 irradiated with the reproduction reference light L4. The reproduced-image light is imaged on the imaging element unit 12 through the collimator lens 11. The 2D image imaged on the imaging element unit 12 is converted into an electric signal, followed by being transferred to the hologram scan controller 15.

The hologram scan controller 15 controls the operation of the imaging element unit 12, and executes processing for the 2D image signal obtained by the imaging element unit 12.

Specifically, the hologram scan controller 15 supplies the imaging element unit 12 with a scan timing signal, a scan address signal, and so on so that the imaging element unit 12 sequentially transfer-outputs 2D image signals obtained by a solid-state imaging element array through so-called imaging operation. Subsequently, for the 2D image signals transferred from the imaging element unit 12, the hologram scan controller 15 executes sampling processing, AGC processing, A/D conversion processing, etc., and then outputs the resultant signals.

The 2D image signal that is output from the hologram scan controller 15 and has been converted into digital data is stored in the information memory 31 under control by the memory controller 21.

For the 2D image signal stored in the information memory 31, the optical correction parameter calculator 22 calculates an optical correction parameter. Specifically, the 2D image signal is transferred from the information memory 31 to the optical correction parameter calculator 22, and the optical correction parameter calculator 22 calculates a correction parameter for brightness adjustment correction and correction of optical distortion, which is variation in the data value due to an optical cause. The optical correction parameter calculator 22 stores the calculated optical correction parameter in the parameter memory 26.

Note that the optical correction parameter calculator 22 does not actually execute optical correction processing for 2D image signals, but merely executes processing of calculating an optical correction parameter and storing it in the parameter memory 26. That is, the optical correction parameter calculator 22 does not implement operation of correcting 2D image signals and transferring the corrected 2D image signals to the information memory 31 so that the 2D image signals are updated to the corrected signals.

The 2D image signal for which the optical correction parameter has been stored in the parameter memory 26 through the processing by the optical correction parameter calculator 22 is transferred from the information memory 31 to the binarizer 24, followed by being binarized therein. The 2D image signal is originally obtained as imaging data with a grayscale depending on the imaging element unit 12. The binarizer 24 executes binarizing processing for converting this grayscale data into binary data of white and black (light and dark). This is because the data that should be read from the hologram memory 3 arises from conversion of original record data into 2D page data as white and black binary data.

In the binarizing, the binarizer 24 uses the optical correction parameter for the 2D image signal, stored in the parameter memory 26, to thereby execute the processing. That is, the binarizer 24 defines the threshold value of the binarizing based on the optical correction parameter.

The execution of binarizing by the binarizer 24 with use of the optical correction parameter results in a state where the binarized 2D image signal has been subjected to optical correction.

The 2D image signal binarized by the binarizer 24 is transferred to the decoder 25 directly or via the information memory 31.

The decoder 25 executes decoding processing and error correction processing for the binarized 2D image signal, i.e., data obtained from one element hologram, to thereby decode the 2D image signal into the element hologram record data DT.

The decoder 25 transmits the decoded data of the element hologram record data DT to the memory controller 21. The memory controller 21 stores the decoded data of the element hologram record data DT in the nonvolatile memory 32.

The 2D image signals obtained from the respective element holograms on the hologram memory 3 are sequentially decoded by the decoder 25 and the decoded data of the element hologram record data DT are accumulated in the nonvolatile memory 32. Thus, finally, the original data recorded in the hologram memory 3 like the data shown in FIG. 2A, such as AV content data or computer data, is constructed on the nonvolatile memory 32.

The data reconstructed on the nonvolatile memory 32 is transferred, as reproduced data from the hologram memory 3, via the external apparatus interface 41 to the external apparatus 100, such as a personal computer, an AV device typified by audio players and video players, or a cellular phone. As the external apparatus interface 41, e.g. a USB interface would be available. It should be obvious that the external apparatus interface 41 may be an interface based on a standard other than the USB standard. A user can utilize the reproduced data from the hologram memory 3 with the external apparatus 100. Specifically, a user can utilize computer data with a personal computer, or can reproduce AV content data with an AV device or cellular phone, for example.

Although not shown in the drawing, a media drive for recording data in a predetermined recording medium may be provided, and reproduced data may be recoded in a recording medium by the media drive.

As the recording medium, e.g. an optical disc or magneto-optical disc would be available. A recordable disk based on any of various systems such as a compact disc (CD) system, a digital versatile disc (DVD) system, the Blu-ray Disc system, and the Mini Disc system would be available as the recording medium. When any of these discs is used as the recording medium, the media drive executes encoding processing, error correction coding processing, compression processing, etc. dependent upon the disc type so that reproduced data is recorded in the disc.

Furthermore, a hard disc would also be available as the recording medium. In this case, the media drive is constructed as a so-called hard disk drive (HDD).

Moreover, the recording medium can be realized also as a portable memory card including therein a solid-state memory or a built-in solid-state memory. In this case, the media drive is constructed as a recording device unit for the memory card or built-in solid-state memory, and records data reproduced through requisite signal processing.

In addition, it would be possible, of course, that the reproducing device includes an audio reproduction and output system and a video reproduction and output system so that e.g. AV content data recorded in a recording medium is reproduced by a media drive and the reproduced AV content data is decoded and output by these systems.

Furthermore, it is also possible that data reproduced by a media drive is transferred via the external apparatus interface 41 to an external apparatus.

If data is recorded in a portable recording medium such as the above-described CD, DVD, Blu-ray Disc, Mini Disc, or memory card, a user can utilize reproduced data read out from the hologram memory 3 by operating the recording medium with an external apparatus.

The following operations may not be simultaneously implemented basically: the reproducing operation (data downloading operation) of scanning the hologram memory 3 to read out data; and the operation of transferring obtained data such as audio data or image data to the external apparatus 100 or of reproducing and outputting the data through a reproduction and output system as described above. If these operations are not implemented simultaneously, the memory configuration can be simplified by replacing either one or both of the information memory 31 and the nonvolatile memory 32 in the memory part 30 by another storage included in the reproducing device.

For example, if the reproducing device is configured so that decoded data is recorded in a recording medium such as the above-described optical disc or HDD, it is also possible to store the data in the information memory 31 until reconstruction of reproduced data, which eliminates the need to provide the nonvolatile memory 32.

[4. Reproduction Processing]

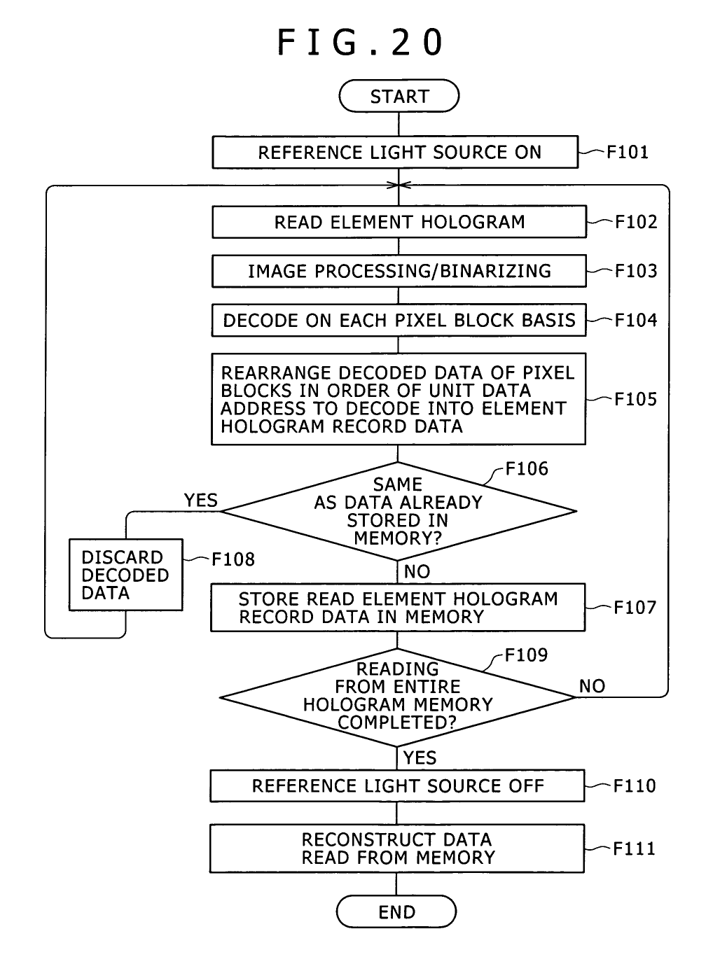

The processing sequence of data reproduction from the hologram memory 3 by the hologram reader 6 will be described below with reference to FIG. 20. FIG. 20 shows the processes executed based on control by the system controller 51 at the time of data reproduction.

A user implements reproduction start operation through the operation unit 53, and then moves the hologram reader 6 in any directions with making the reader 6 face the hologram memory 3 as shown in FIG. 5 or 6.

Upon detection of the reproduction start operation through the operation unit 53, the system controller 51 turns on the reference light source in a step F101. Specifically, the system controller 51 instructs the light-emission driver 14 to drive the reference light source 16 to emit light, to thereby make a state where the hologram memory 3 can be irradiated with the reproduction reference light L4.

In this state, the user moves the hologram reader 6 with making the reader 6 face the hologram memory 3, which allows the reproduced-image light L5 of element holograms on the hologram memory 3 to be sequentially detected by the imaging element unit 12.

If the hologram reader 6 includes the camera control mechanism 13 so that the scanning position is controlled by the camera control mechanism 13, upon the start of scanning, the system controller 51 instructs the hologram scan controller 15 to start the operation of the camera control mechanism 13. The following description is based on an assumption that the scanning system is based on manual scanning and the camera control mechanism 13 is absent.

In a step F102, due to the operation of the imaging element unit 12 and the hologram scan controller 15, digital data as the image signal of the 2D image of an element hologram is achieved.

The hologram scan controller 15 executes requisite signal processing and A/D conversion for the imaging signal obtained by the imaging element unit 12, and then transmits the resultant signal as the 2D image signal of the element hologram to the memory controller 21, so that the memory controller 21 stores the data in the information memory 31.

Note that in the step F102, the 2D image DP within the range imaged on the effective imaging pixel area 12A of the imaging element unit 12 is captured as described with FIGS. 9 to 18.

Upon acknowledgement of the capturing of the 2D image signal of the element hologram as the operation in the step F102, the system controller 51 executes image processing in a step F103 for the 2D image signal. Specifically, in the step F103, the system controller 51 causes the optical correction parameter calculator 22 to execute processing for the 2D image signal loaded in the information memory 31, so that an optical correction parameter is stored in the parameter memory 26. Subsequently, the system controller 51 causes the binarizer 24 to execute binarizing processing with use of the optical correction parameter for the 2D image signal loaded in the information memory 31.

Subsequently, in steps F104 and F105, the binarized 2D image signal is transferred to the decoder 25, followed by decoding processing by the decoder 25.

The decoding processing in the step F104 is executed for the captured 2D image DP on each pixel block basis. Specifically, the 2D image DP is divided into each pixel block B as shown in e.g. FIG. 7, and the decoding processing is carried out for each pixel block B.

For example, through the decoding processing for one pixel block B01, the unit data DT01 and the unit data address Ad01 are obtained as shown in FIG. 2E.

The decoder 25 sequentially executes processing for the pixel blocks to thereby obtain the unit data and unit data addresses from the respective pixel blocks.

After the decoding for all the pixel blocks within the range of the captured 2D image has been completed in the step F104, the decoded data are rearranged to form the element hologram record data DT in the step F105.

Specifically, the unit data that have been decoded in random order are rearranged in the order of the unit data address Ad (Ad00, Ad01 . . . ). Thus, from the respective unit data of FIG. 2E, a data train equivalent to the element hologram record data DT of FIG. 2B is obtained. For this data train, further requisite decoding processing such as deinterleaving and error correction processing are executed so that the header and decoded data as the data block BLK of the element hologram record data DT are achieved.

After the decoded data of the element hologram record data DT of one element hologram has been obtained in the step F105, in a step F106, a determination is made as to whether or not the decoded data has been already stored in the nonvolatile memory 32.

If it is determined that the decoded data has not been stored in the nonvolatile memory 32 yet, the processing sequence proceeds to a step F107, where the decoded data as the element hologram record data DT is stored in the nonvolatile memory 32.

In a step F109, a determination is made as to whether or not the reading out of data from the hologram memory 3 has been completed. Specifically, a determination is made as to whether or not the necessary amount of the data blocks BLK to reconstruct reproduced data has been stored in the nonvolatile memory 32.

If the data reading from the hologram memory 3 has not been completed, the processing sequence returns to the step F102, and the above-described processes are executed again similarly.

In the header information (header in the element hologram record data DT) recorded in the element holograms at the time of the recording, the data size of the entire record data (e.g., the entire content data), the number of the data blocks, the data block numbers, and so on are recorded.

Therefore, in the determination in the step F106 as to whether or not the decoded data has been already stored in the nonvolatile memory 32, e.g. the data block number as the header information of the decoded data is checked to confirm whether or not the decoded data having the same data block number has been already stored in the nonvolatile memory 32.

In addition, since the data size of the entire record data (e.g., the entire content data) and the number of the data blocks are recorded in the header information, the system controller 51 can confirm the data size of the entire data that should be read and the number of the data blocks therein when decoding of certain first one element hologram record data DT has been completed.

Accordingly, in the step F109, whether or not the reading from the hologram memory 3 has been completed can be determined by comparing the data size or the number of the data blocks of the entire data with the data size or the number of the data blocks of the data that has been stored in the nonvolatile memory 32.

Even before the reading of all the element holograms on the hologram memory 3 has been completed, it may be determined in the step F109 that the data reading from the hologram memory 3 has been completed, i.e., the reading of the element holograms has been completed, as long as the data of a predetermined amount of the data blocks necessary to construct reproduced data (original record data) has been read.

This is because there is a possibility that plural element holograms each including the same data are recorded in the hologram memory 3, and because there is a case where the original record data can be constructed through error correction processing and data interpolation processing without reading all the data blocks.

If it is determined in the step F106 that the decoded data is the same as data that has been already stored in the nonvolatile memory 32, the processing sequence proceeds to a step F108.

The state where the data decoded by the decoder 25 is the same as data that has been already stored in the nonvolatile memory 32 occurs in the following cases: (1) the same element hologram has been already read; and (2) plural element holograms each including the same data are recorded in the hologram memory 3, and the same data has been already read from an element hologram other than the presently read element hologram.

When manual scanning is carried out as described above, which element hologram is to be scanned is not definite at all, and the same element hologram is possibly scanned plural times.

For a system that permits stochastic reading of element holograms for the manual scanning in particular, there is an idea that plural element holograms each including the same element hologram record data DT are recorded in the hologram memory 3 so that the element holograms of the respective data blocks are read as rapidly as possible.

For the above-described reasons, the element hologram record data DT including the same data as data that has been already stored is often decoded. To address this, the determination of the step F106 is implemented. If the element hologram record data DT that has been already stored in the nonvolatile memory 32 is decoded again, the processing sequence proceeds to the step F108, where the decoded data is discarded, followed by return to the step F102.

Although not shown in the flowchart, also when a decoding error occurs and thus the element hologram record data DT fails to be obtained adequately in the steps F104 and F105, the data is discarded and the processing sequence returns to the step F102.

If it is determined in the step F109 that the reading from the hologram memory 3 has been completed, the processing sequence proceeds to a step F110, where the system controller 51 instructs the light-emission driver 14 to turn off the reference light source 16.

Subsequently, in a step F111, the system controller 51 instructs the memory controller 21 to reconstruct the read-out data stored in the nonvolatile memory 32. Specifically, since a predetermined amount of the data, i.e., the data of the necessary amount the data blocks BLK to construct the original record data is stored in the nonvolatile memory 32 at this timing, the respective data blocks are arranged in the order of the block number to thereby reconstruct the original content data or the like shown in FIG. 2A, so that the reconstructed data is offered as reproduced data. Thereafter, the reproduced data is output via the external interface 41 to the external apparatus 100 for example, which allows a user to use the reproduced data with the external apparatus 100.

The above-described embodiment can offer the following advantages.

In each element hologram on the hologram memory 3, a 2D image representing the element hologram record data DT is recorded. As described with FIGS. 9 to 18, the inside area ARi of the 2D image contains each unit data of the element hologram record data DT, and all or part of the unit data is recorded in the outer peripheral area ARo. That is, all or part of the unit data is recorded in one 2D image DP plural times.

Thus, even when a geometric misalignment has occurred at the time of capturing of the 2D image of an element hologram, the captured 2D image is allowed to include all or most of the unit data (DT01, DT02 . . . ) included in the element hologram record data DT. Therefore, the decoded data of the element hologram record data DT can be achieved by decoding the respective unit data and accumulating the decoded data, which leads to an advantage that favorable reproducing operation with a suppressed error rate can be realized.

In addition, it is also possible that a plurality of each of the unit data are included in the inside area ARi. This configuration allows adequate decoding of the respective unit data and reduction in the error rate even when a geometric misalignment such as a rotational misalignment has occurred.

Furthermore, this feature eliminates the need for the hologram reader 6 to execute processing for correcting geometric misalignments, which can promote simplification of the configuration of the hologram reader 6 and an improvement in efficiency of processing for 2D image signals.

In addition, in the above-described embodiment, a correction parameter for optical correction is calculated for a 2D image stored in the information memory, and the correction parameter is stored in the parameter memory 26. Subsequently, the binarizer 24 executes binarizing based on the correction parameter stored in the parameter memory 26, which results in realization of reproduction of information for which the optical correction has been implemented. In the embodiment, since optical correction processing is not directly executed for a 2D image stored in the information memory 31, writing of the corrected 2D image to the information memory 31 is also not executed. Therefore, the burden of processing of access to the information memory 31 necessary to execute the optical distortion correction and the burden of the accompanying processing time can be eliminated, which can achieve an improvement in the reproduction processing efficiency.

Furthermore, the absence of correction processing for a 2D image itself until the execution of the binarizing offers a further advantage of suppression of arithmetic errors accompanying the correction.

Furthermore, in the embodiment, the data that have been read out from element holograms and have been decoded are sequentially accumulated in the nonvolatile memory 32, and finally the reproduced data from the respective element holograms is reconstructed on the nonvolatile memory 32, so that the reproduced data of content data or the like is formed. This feature means that element holograms on the hologram memory 3 may be read out in arbitrary order. Therefore, the reproducing device of the embodiment is suitable for the system, described with FIGS. 5 and 6, in which manual scanning is employed and therefore element holograms are read out in random order. Furthermore, when the scanning position is varied and controlled by the camera control mechanism 13, the above-described feature can offer high flexibility in this variation control operation.

An embodiment of the invention has been described above. However, it should be noted that the configuration and processing sequence of the hologram reader 6 in the embodiment are merely one example, and various modifications might be incorporated in the embodiment without departing from the scope and spirit of the invention.

Furthermore, it should be obvious that there are further variations of the arrangement of pixel blocks in the 2D image DP recorded as an element hologram, besides the arrangements shown in FIGS. 9 to 18.

According to the invention, in each element hologram on a hologram recording medium, a 2D image representing element hologram record data is recorded. An inside area of the 2D image contains each unit data of the element hologram record data, and all or part of the unit data is recorded in an outer peripheral area. That is, all or part of the unit data is recorded in one 2D image plural times.

Thus, even when a geometric misalignment has occurred at the time of capturing of the 2D image of an element hologram, the captured 2D image is allowed to include all or most of the unit data included in the element hologram record data. Therefore, the decoded data of the element hologram record data can be achieved by decoding the respective unit data and accumulating the decoded data, which leads to an advantage that favorable reproducing operation with a suppressed error rate can be realized.

In addition, it is also possible that a plurality of each of the unit data are included in the inside area. This configuration allows adequate decoding of the respective unit data and reduction in the error rate even when a geometric misalignment such as a rotational misalignment has occurred.

What is claimed is:

1. A hologram recording medium in which image data of a predetermined amount of data arising from division of record data into each predetermined amount of data and conversion of resultant data into image data is recorded as an element hologram by use of an interference fringe due to interference between object light of the image data and recording reference light, wherein
unit holograms included in the element hologram are arranged in a predetermined region in the recording medium so that all of the unit holograms included in the element hologram are contained in a predetermined area.

2. The hologram recording medium according to claim 1, wherein
the unit holograms are arranged into a square of n×n holograms in the predetermined area that contains all of the unit holograms included in the element hologram.

3. The hologram recording medium according to claim 1, wherein
all of the unit holograms included in the element hologram are provided with discrimination information different from each other.

4. A hologram recording medium in which a two-dimensional image arising from conversion of element hologram record data including a plurality of unit data is recorded as one element hologram by use of an interference fringe due to interference between object light of the two-dimensional image and recording reference light, the two-dimensional image comprising:
an inside area that contains all of the unit data included in the element hologram record data; and
an outer peripheral area that surrounds the inside area and contains all or part of the unit data.

5. The hologram recording medium according to claim 4, wherein
the inside area is defined as an area corresponding to an effective imaging pixel area in a reproducing device that reads out data from a hologram recording medium.

6. The hologram recording medium according to claim 4, wherein
the inside area contains a plurality of each of all the unit data included in the element hologram record data.

7. The hologram recording medium according to claim 4, wherein
a center area and a surrounding area are defend in the inside area so that the center area contains all of the unit data included in the element hologram record data and the surrounding area contains all or part of the unit data.

8. A reproducing device that reproduces record data from a hologram recording medium in which image data of a predetermined amount of record data arising from division of record data into each predetermined amount of data and conversion of resultant data into image data is recorded as an element hologram by use of an interference fringe due to interference between object light of the image data and recording reference light, the hologram recording medium having a predetermined region in which unit holograms included in the element hologram are arranged so that all of the unit holograms included in the element hologram are contained in a predetermined area, the reproducing device comprising:
imaging means for emitting reproduction reference light to the hologram recording medium and capturing a two-dimensional image arising as reproduced-image light from an element hologram on the hologram recording medium; and
decoding means for executing decoding processing for a two-dimensional image obtained by the imaging means on each unit data basis and collecting decoded unit data to thereby obtain decoded data of one element hologram record data.

9. The reproducing device according to claim 8, further comprising
storing means for storing therein the decoded data on each element hologram basis, wherein
the decoding processing is executed based on discrimination information assigned to all of the unit holograms that are included in the element hologram and are contained in the predetermined area so that all of the unit holograms are discriminated from each other, and the decoded data is stored in the storing means based on the discrimination information.

10. The reproducing device according to claim 8, wherein
the imaging means is allowed to capture an area equal to or larger than the predetermined area that contains all of the unit holograms included in the element hologram.

11. A reproducing device that reproduces record data from a hologram recording medium in which image data of a predetermined amount of record data arising from division of record data into each predetermined amount of data and conversion of resultant data into image data is recorded as an element hologram by use of an interference fringe due to interference between object light of the image data and recording reference light, the hologram recording medium having a predetermined region in which unit holograms included in the element hologram are arranged so that all of the unit holograms included in the element hologram are contained in a predetermined area, the reproducing device comprising:
an imaging section configured to emit reproduction reference light to the hologram recording medium and capture a two-dimensional image arising as reproduced-image light from an element hologram on the hologram recording medium; and
a decoding section configured to execute decoding processing for a two-dimensional image obtained by the imaging section on each unit data basis and collect decoded unit data to thereby obtain decoded data of one element hologram record data.
